(19) United States
(12) Patent Application Publication
(10) Pub. No.: US 2025/0249416 A1
(43) Pub. Date: Aug. 7, 2025

(54) MIXING DEVICE

(71) Applicant: Aaron James BONK, Reno, NV (US)

(72) Inventor: Aaron James BONK, Reno, NV (US)

(21) Appl. No.: 19/044,537

(22) Filed: Feb. 3, 2025

Related U.S. Application Data
(60) Provisional application No. 63/549,521, filed on Feb. 4, 2024.
(60) Provisional application No. 63/749,604, filed on Jan. 26, 2025.
(60) Provisional application No. 63/749,658, filed on Jan. 26, 2025.

(51) Int. Cl. B01F 31/20; B01F 31/00; B01F 101/23

(52) U.S. Cl. CPC B01F 31/201; B01F 31/70; B01F 2101/23

(57) ABSTRACT

A mixing device has a plate that defines a cradle for receiving containers of various types capable of holding samples and reagents. The rectangular plate is mounted at its corners to mounts which in turn connect to motors. An adapter plate translates the rotational output of the motor to reciprocating vertical motion of the mounts. The motors can be controlled to sequentially drive the mounts up and down thereby creating three dimensional motion of the plate and inducing a vortex into the liquids with a container received into the nest plate.

### CROSS REFERENCE TO RELATED APPLICATIONS

This application claims priority to U.S. Provisional Patent Application Ser. Nos.: 63/549,521 filed 4 Feb. 2024, 63/749,604 file 26 Jan. 2025 and 63/749,658 filed 26 Jan. 2025, the entire contents of each of which are incorporated herein by reference.

### FIELD OF THE INVENTION

The present invention relates to mixing of liquids in particular for subsequent analysis.

### BACKGROUND OF THE INVENTION

Sample processing in biochemistry and biopharmaceutical laboratories often includes mixing of a single liquid, more than one liquid, and mixing of the liquid(s), particulates (e.g. magnetic beads), and removal of waste and/or removal of a target reagent. Typical sample/reagent volumes may be approximately 10 mls when processing blood whereas the specific volume depends on the specific sample type and/or testing procedure. For example, a urine sample may be 50 mls or more depending on the target molecule to be examined. Alternatively, the sample volume being processed may be very low (e.g. less than 1 ul) when appropriate for a given assay.

A number of devices have been developed for mixing liquid samples. However, these devices fail to thoroughly mix samples in a cost effective and efficient manner. What has long been needed are devices, systems and processes for thoroughly mixing samples and reagents in an efficient and cost effective manner.

### SUMMARY OF ONE EMBODIMENT OF THE INVENTION

### Advantages of One or More Embodiments of the Present Invention

The various embodiments of the present invention may, but do not necessarily, achieve one or more of the following advantages:
the ability to mix liquid samples and reagents;
the ability to mix samples containing particulates and suspensions;
the ability to move a container in three dimensions to enhance mixing;
the ability to generate a vortex in a liquid within a container.

These and other advantages may be realized by reference to the remaining portions of the specification, claims, and abstract.

### Brief Description of One Embodiment of the Present Invention

In one aspect of the present invention, there is provided a mixing device. The mixing device may include a plurality of motors supported by a framework. The motors may be operatively supported by the motors via a plurality of mounts. The motors may reciprocally drive the mounts in a vertical direction.

In one embodiment, there is provided a method for mixing using a mixing device. The mixing device may include a plurality of motors supported by a framework. The motors may be operatively supported by the motors via a plurality of mounts. The motors may reciprocally drive the mounts in a vertical direction. The method may comprise disposing at least one container in the plate nest and operating the motors to induce a mixing motion in the container.

In one aspect, there is a provided a mixing device comprising motor means for outputting a circular motion and frame means for supporting the motor means. Mount means for converting circular motion of the motor means to reciprocating vertical motion may also support plate nest means for receiving at least one container.

In one aspect, there is provided a container for use with a mixing device. The container may include a base that is adapted to fit snugly within a plate nest of the mixing device. The base may support a vessel. The container may include a rack that supports a tube vessel. Alternatively, the container may support a series a posts that in turn support a vessel therebetween.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows an underside view of an embodiment of a mixing device with the framework and housing omitted;

FIG. 2 shows a cross section side view of the mixing device;

FIG. 3 shows an upperside perspective view of the mixing device;

FIG. 4 shows an upperside perspective view of the mixing device with the housing removed;

FIG. 5 shows an alternative upperside perspective view of the mixing device with the housing removed;

FIG. 6 schematically depicts how a container tilts during mixing;

FIG. 7 schematically depicts corner motion during a mixing cycle;

FIG. 8 schematically depicts a neutral position and a mixing position;

FIG. 9 schematically depicts the use of liquid handling tubes;

FIG. 10 schematically depicts a magnetic system for use with the mixing device;

FIG. 11 substantially depicts a mixing cycle;

FIG. 12 substantially depicts a tilting cycle;

FIG. 13 shows a vessel in the mixing device;

FIG. 14 shows a set of test tubes in the mixing device;

FIG. 15 shows a flask in the mixing device;

FIG. 16 shows a set of cell culture flasks in the mixing device;

FIG. 17 shows a single test tube in the mixing device;

FIG. 18 shows a set of test tubes in the mixing device;

FIG. 19 shows a first resuspension plot produced using the mixing device;

FIG. 20 shows a second resuspension plot produced using the mixing device;

FIG. 21 schematically depicts the mixing device include control circuitry;

FIG. 22 shows an embodiment of a container for supporting tubes in the mixing device;

FIG. 23 shows an embodiment of a container for supporting a vessel between posts.

FIG. 24 shows an embodiment of a mixing device which uses gears to produce vertical movements of the mounts;

FIG. 25 shows an embodiment of a mixing device which uses a crankshaft to produce vertical movements of the mounts.

FIG. 26 shows an embodiment of a mixing mechanism which uses linear drives to produce vertical movements of the mounts.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The system described herein provides a novel system of instruments, consumables and methods for the automated processing of laboratory samples/reagents including mixing, heating/cooling, addition/removal and magnetic bead capture thereby reducing the likelihood of errors introduced via human interaction. Many laboratories use robots to manipulate samples and containers. For example, robots may be used to pick up containers, add substances to containers, cap or close the containers, place the containers in mixing and other devices, unloaded the containers, uncap or open the containers and take test samples from the containers.

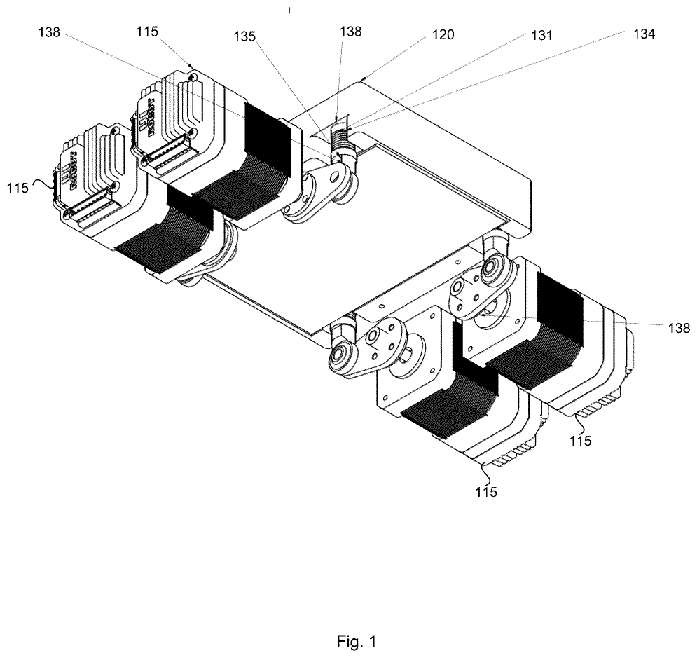

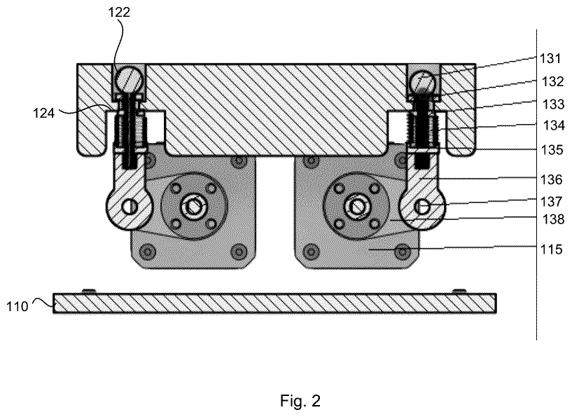

FIGS. 1 to 5 illustrate a mixing device in accordance with an embodiment of the present disclosure. The device 100 includes a framework 110 that supports a plurality of motors 115 arranged on the framework. The motors 115 each provide a support for a plate nest 120 by way of mounts 130. The mounts are shown in FIGS. 1 and 2 and include a ball bolt 131, washers 132, 133, spring 134, spring capture nut 135, bearing 136, bolt 137 and shaft adaptor 138.

As seen most clearly in FIG. 2, the plate nest 120 rests atop the mounts. Shafts 122 in the plate nest 120 have a midway plate 124. The ball bolt 131 is received into the shafts 122 from the top, passes through the midway plate 124 and is then secured into the bearing 136. The spring 134 is captured between the midway plate 124 and the bearing 136 and held in place by the spring capture nut 135. The bearing 136 connects to the motor 115 via a shaft adapter 138 which is secured by a bolt 137. The shaft adapter 138 receives the output shaft of the motor 115 and converts the rotational motion of the output shaft into vertical (up and down) motion. Through this mounting arrangement, the plate nest 120 is operatively coupled to the motors 110. Each motor may be operated to rotate the shaft back and forth through approximately a quarter turn, in the process raising and lowering the plate nest 120 via the adapter plate 138 and spring mount 130.

In one embodiment, there are four motors 115, each being mounted adjacent a corner of the plate nest 120. In one embodiment, the plate nest 120 may be substantially rectangular. This provides the plate nest with an x-axis and a y-axis that have different lengths. The motion generated as the plate nest tips along the x-axis is therefore different to the motion generated as the plate nest tips along the y-axis, which can contribute to the generation of a vortex. In an alternative embodiment, the plate nest may be substantially square.

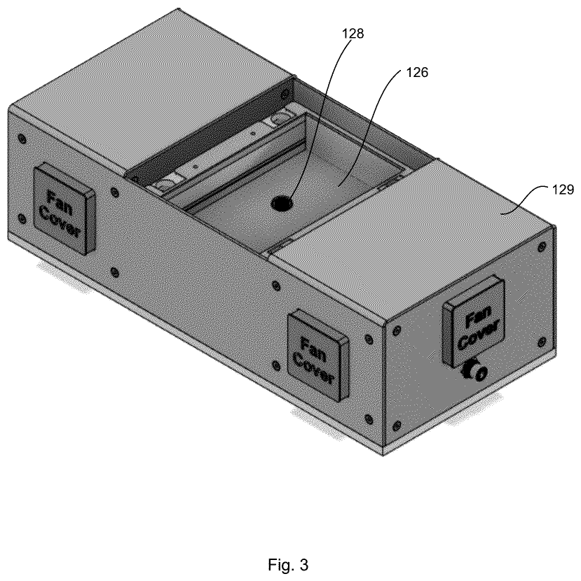

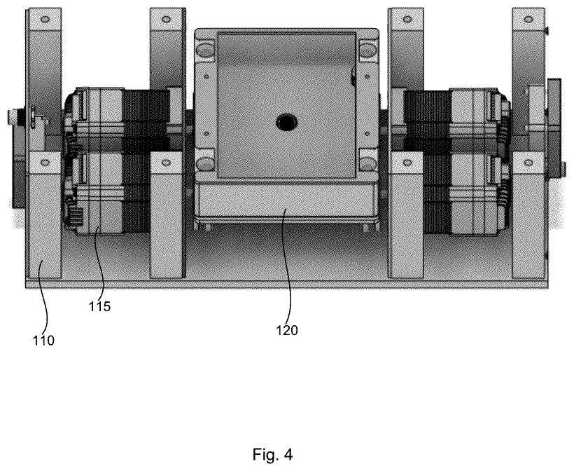

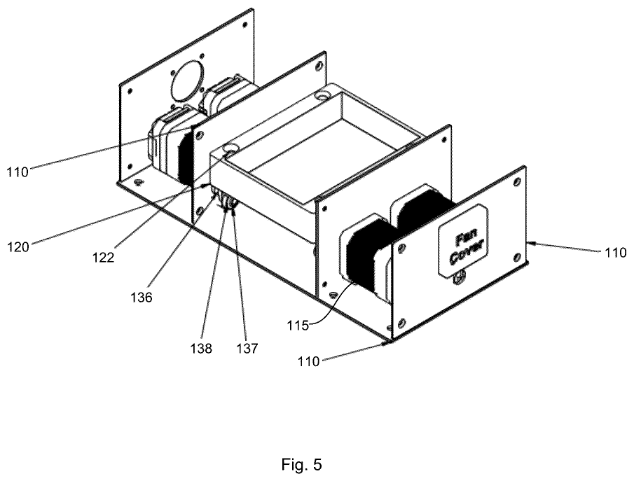

The plate nest is seen from above in FIGS. 3 to 5. The plate nest 120 includes a flat bottomed cradle 126 that can support containers, including rectangular and circular containers. In the middle of the cradle 126 is a circular divot 128 that can provide support to smaller containers, such as test tubes. FIG. 3 shows the device 100 with cover housing 129 over the framework, leaving the plate nest 120 exposed. FIGS. 4 and 5 show the device 100 with the cover housing removed to show how the motors 115 and plate nest 120 fit within the framework 110 in various embodiments.

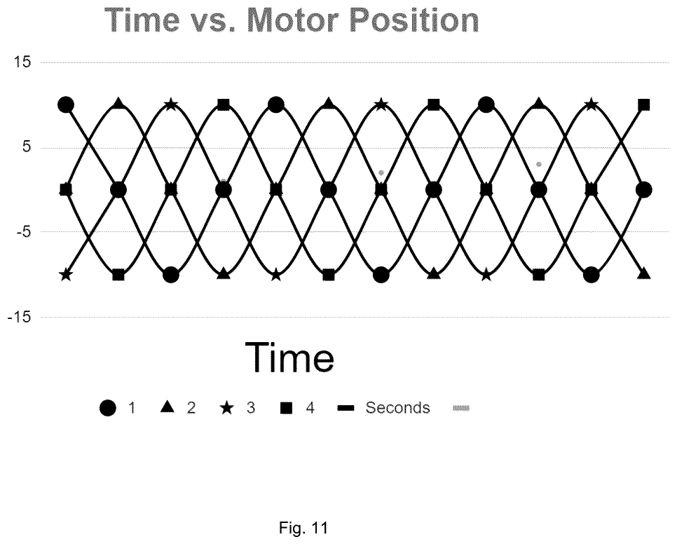

As each motor is operated, the mount attached to the respective motor is raised and lowered. To operate the mixing device, the motors are powered to drive the mounts and in turn the corners of the plate nest. In one embodiment, the motors drive the mounts non-synchronously so that a container within the plate nest is imparted with a mixing motion, e.g. tilting, shaking, circular, vortex. In one embodiment, the motors may be driven to create a mixing cycle. In a mixing cycle, the operation of the motors is coordinated so that only one mount reaches its maximum height at a time, sequentially moving around the rectangular plate nest in a circle. In one embodiment, the mounts may be labelled 1, 2, 3, 4 in a circle. FIG. 11 shows an example of a motion sequence that shows the height of each mount 1, 2, 3, 4 over time. The corners of the platform are raised and lowered in a synchronized manner. It can be seen that each corner reaches its peak in isolation of the others and that the next corner to reach its peak is adjacent the current corner, instead of the diagonally opposite corner. This rotational motion can be used to induce a vortex into liquids within a container that is supported by the plate nest. The specific height of the change will depend on the size of the container. Larger containers require larger movements than smaller containers to achieve mixing or to induce vortex formation.

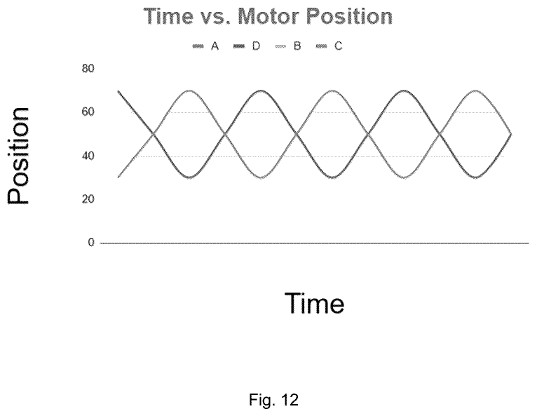

The motors may also be operated in a tilt cycle. In this embodiment, motors A and B may be stationary while motors C and D are driven. This will cause the plate nest 120 to tip back and forth. An example motion sequence is shown in FIG. 12.

The person skilled in the art will recognize that the motors may be programmed to operate in various sequences. For example, in an alternative tilting cycle, diagonally opposite corners may be driven sequentially while the other diagonally opposite corners remain stationary. Motors may be uniformly or randomly operated. A large array of drive patterns to create different mixing effects will be apparent to the person skilled in the art.

A particular advantage of the mixing device of the present embodiments includes that the container is moved through three dimensions as opposed to the two dimensions provided by prior art orbital mixer plates. By moving the container through three dimensions, a tilt can be induced in the container walls, which facilitates mixing including facilitating a vortex within the container.

The mixing mechanisms described herein provide a potentially useful tool in developing heretofore unknown sample and reagent mixing and processing technology. In addition to the instrumentation described herein, various consumable and reusable containers as will be described below may be used to optimize mixing by using a rotational mixing strategy. For example, the mixing process uses the movement of the container walls, sides and/or top to facilitate liquid movement within the container. The movement of the container inner walls (e.g. bottom, sides and top) may be clockwise, counterclockwise, alternating opposite sides, or any variation whereby the number of degrees of freedom (e.g. the number of specific angles that the container moves around the central axis during the mixing process) may be limited only by the geometry of the respective container. Examples of mixing processes with two degrees of freedom include repeated movements to the front and back sides or repeated movements to the right and left sides. The mixing process involves moving the container sides in a specific movement pattern or may include a random variable which improves the thoroughness of the mixing process. Examples of mixing processes with four degrees of freedom include repeated movements to the front right, back and right sides. The mixing process involves moving the container sides in a specific movement pattern or may include a random variable which improves the thoroughness of the mixing process. In general, the mixing strategy is based on combinations of movements with the respective container geometries based on the edges or corners or based on any other features of the inner container.

The mixing process involves moving the container sides in a specific movement pattern or may include a random variable which improves the thoroughness of the mixing process. For example, random variables may include the speed of the mixing process, the amplitude of the plate movement and the direction of the mixing process. Randomly changing these variables increases turbulence of the samples and reagents in the container.

The total required volume of the container is a function of the mixing parameters, the vessel geometry, the sample/reagent volumes, the sample/reagent viscosities and the specific movements imparted to the container. Generally, the container volume will be inversely correlated with the sample/reagent viscosity. Additionally, the container volume may be positively correlated with composite mixing energy applied to the container. For example, processing 15 ml sample/reagent may require a 50 ml container if the imparted composite mixing energy is relatively high. Conversely, a 50 ml container may be appropriate for processing a 30 ml total sample/reagent volume if the imparted composite mixing energy is relatively low. The upper and lower volume limits of the container will be based on sample volume plus reagents as well as the function of the mixing parameters required for the given assay or process.

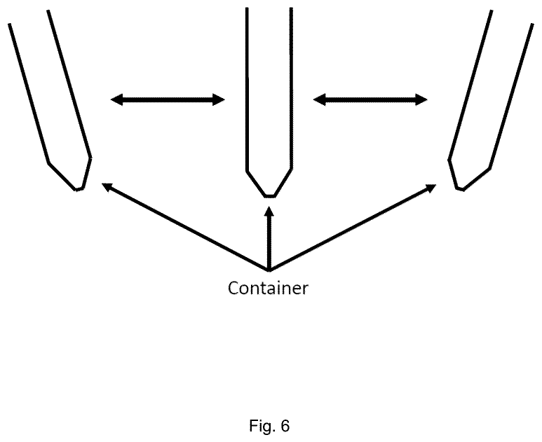

FIG. 6 shows how the container may be positioned at various angles during the mixing procedure. Coordinated movement of the container walls, bottom and top induces movement of the container contents, thereby facilitating mixing. The container orientation when the lower orbit is increased during the Mixing process.

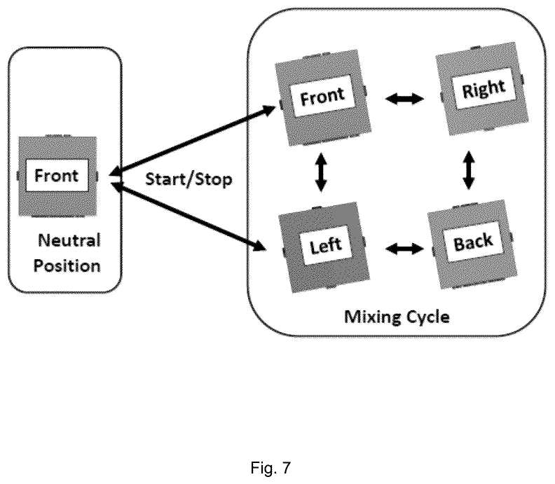

An alternative embodiment of the mixing mechanism uses vertical movements such that the edge(s) or the corner(s) of the bottom of the container are moved up relative to the other edge(s) or the corner(s) of the bottom of the container. FIG. 7 shows an example of a container with the sides labeled. The neutral position is characterized by a lack of motion and the container bottom resting horizontally. Differential positioning of the corners or sides may occur sequentially around the bottom edges of the container, as shown in FIG. 7, where the container started at the neutral position and the containers' right, back, left, and front sides are raised respectively. Sequential repositioning of the container drives sample and reagent mixing. The container may be repositioned at various angles around the container central axis during the mixing cycle. Sequential tilting of the container around a central axis may induce a vortex to form in the sample/reagents or may mix the sample/reagents based on induced turbulence.

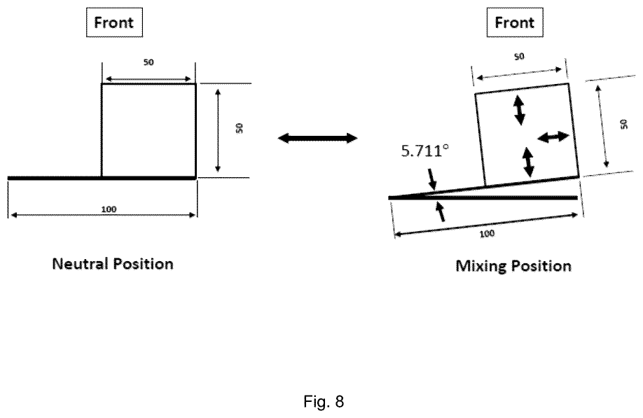

Changing the position of the container around a central or non-central axis causes the inner walls of the container to move towards and away from the central axis as illustrated for a 5° movement of the container bottom as shown in FIG. 8.

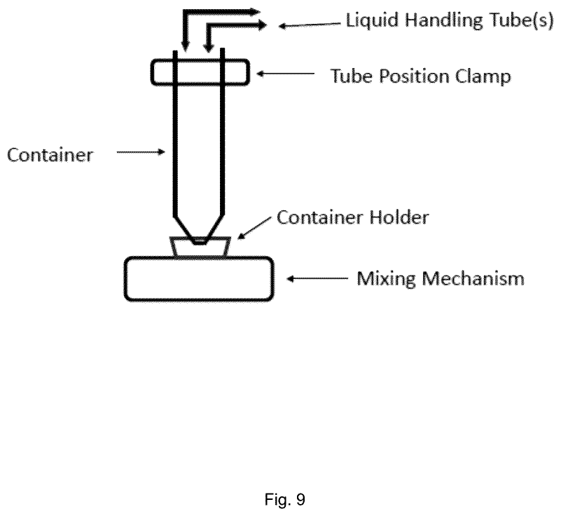

Sample and reagent addition and removal may be mediated with the liquid handling tubes (FIG. 9). The liquid handling tubes may be reusable or consumable. The liquid handling tubes may terminate at the top of the container, at the bottom of the container, or anywhere in between the top and the bottom of the container. The liquid handling tubes may be stationary during the mixing cycle or may be moved in/out of the container to add/remove the sample/reagents. In addition, the liquid handling tubes may add or remove the sample/reagents when the mixing device is active or when it is inactive. Sample and reagent mixing is mediated via movement of the container, changing the relative angle of the vessel walls thereby inducing movement of the samples/reagents. In addition, turbulence is generated when the sample/reagents by the liquid handling tubes(s) when the container is going through a mixing cycle. The samples and reagents can also be mixed directly by aspirating/dispensing with the liquid handling tubes(s) when the container is or is not mixing.

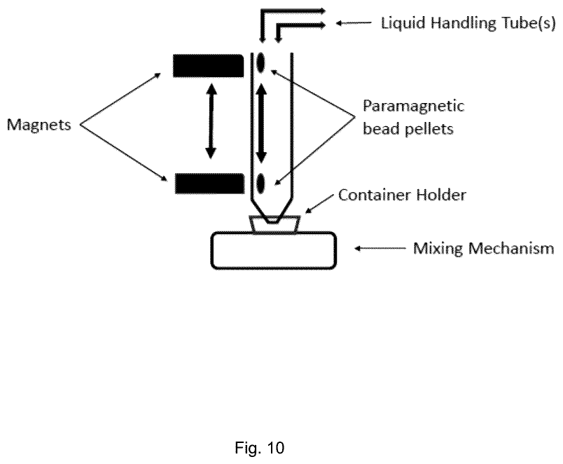

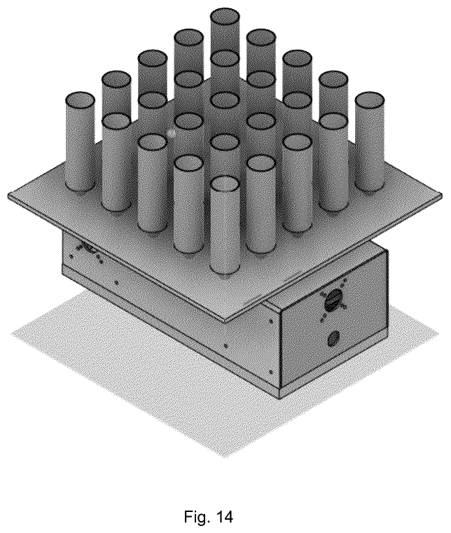

Paramagnetic particles may be captured on the inner wall of the container via a dynamic magnet positioning system. As shown in FIG. 10, the magnet(s) have a range of positions that functionally includes the top of the container, but the actual range of positions may be above or below the container. The paramagnetic beads collected with the dynamic magnet system (FIG. 14) during processing are typically resuspended with orbital mixing of the container or are resuspended by tip mixing (e.g. aspirating/dispensing the sample/reagent in proximity of the paramagnetic bead thereby disrupting the paramagnetic pellet and resuspending the beads in a liquid reagent/sample). A moveable magnet system can capture the magnetic/paramagnetic beads on the inside of the tube at the appropriate time during the process. The paramagnetic beads may be captured at various locations within the container by moving the magnet as needed. Potential range of positions identified with the arrow and where the captured paramagnetic beads are shown in ovals in the figure.

The plate nest may include spring clips or spring loaded ball bearings for retaining the plate nest within the device and allowing removal of the plate nest. Magnetic retainers may also be used for securing adaptor plates during mixing operations. Magnetic retainers may include rare earth, fixed position magnets, sliding magnets and electromagnets.

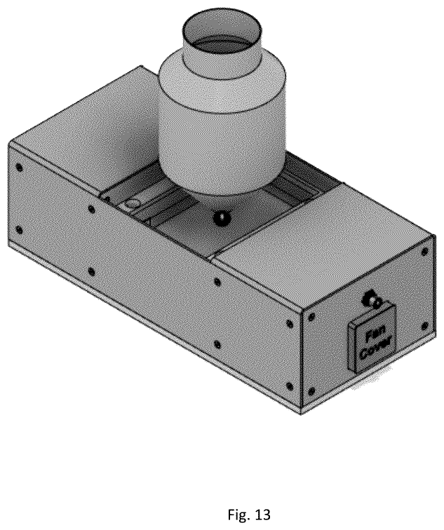

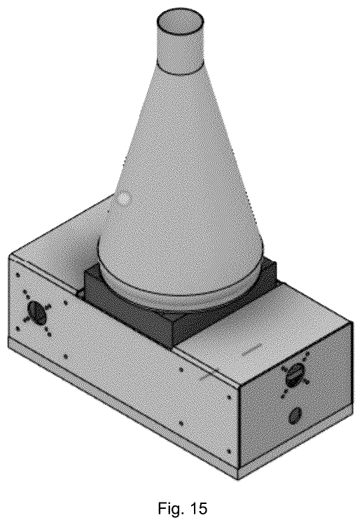

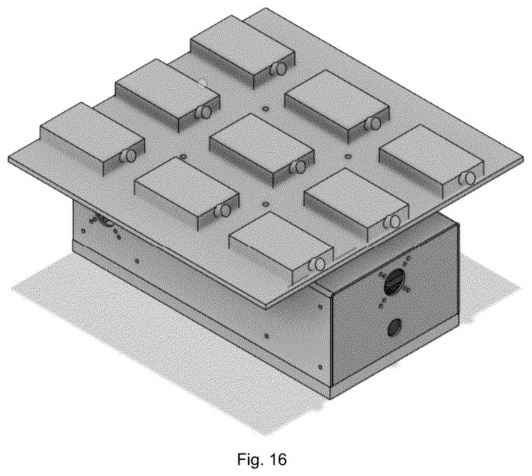

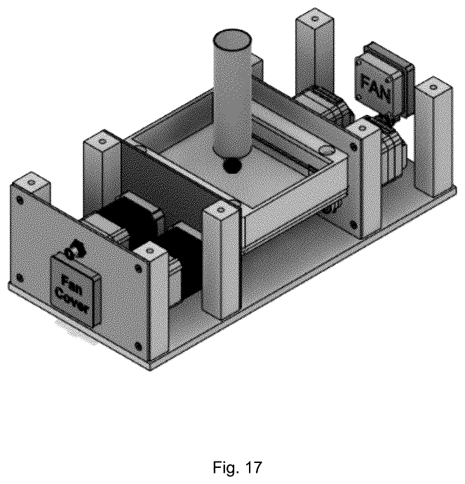

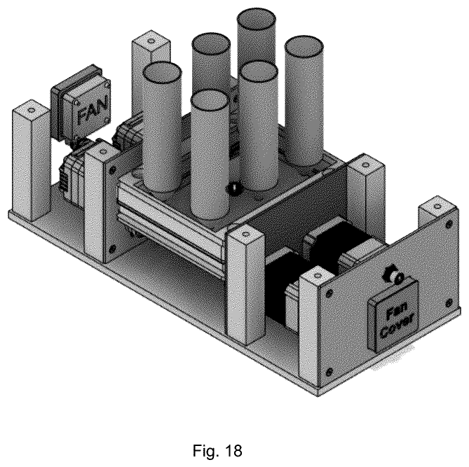

Various containers may be developed for use with the plate nest. Examples of containers include a vessel (FIG. 13) with a base that is configure to be received in the divot 128 of the plate nest. FIG. 14 shows a container for supports a plurality of tubes, the base of the container being configured for being received in the cradle 126 of the plate nest. FIG. 15 shows an Erlenmeyer flask with an integrated base that can be received into cradle. FIG. 16 shows a cell culture flasks on a similar integrated base. FIG. 17 shows a single tube configured for the divot 128 while FIG. 18 shows a base for the cradle 126 that is able to support multiple tubes.

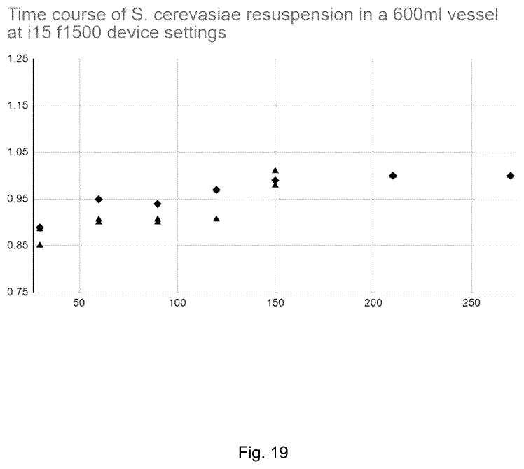

FIG. 19 graphically illustrates the efficiency of resuspending 100 mls of S. cerevisiae in a 600 ml vessel placed into the mixing device and operated at platform delta of 6.4 mm and a speed of 180 cycles per minute. After incubation, the culture was allowed to settle for 12 to 18 hours before starting the resuspension process. The vessel was mixed at the platform corner movement delta of 6.4 mm and a speed of 180 cycles per minute before stopping the mixing and collecting the cells. The cells were collected after each of five 30 second mixing cycles and after two 60 second mixing cycles by stopping the mixing and immediately collecting 100 ul from a position 20 mm above the bottom of the vessel. Approximately 10 ul was transferred to the hemacytometer. The cell concentration was determined with a hemacytometer by counting the number of cells in each of the four corner squares and using the average to calculate the number of cells per ml. The control concentrations were calculated by resuspending the remaining respective cultures and counting the cells as previously described. The percentage resuspension results were calculated by dividing the number of observed cells by the control concentrations.

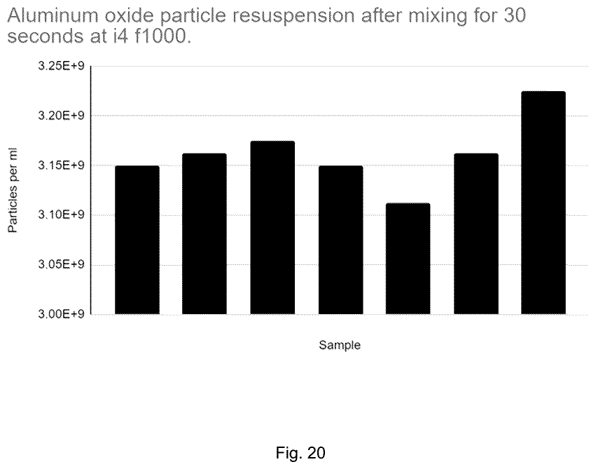

FIG. 20 graphically illustrates the efficiency of resuspending a 10 ml aluminum oxide/water mixture in a 50 ml tube for 30 seconds at the speed of 475 cycles per minute and a platform corner movement delta 1.7 mm. The iron oxide particles were collected after the 30 second mixing cycle by stopping the mixing and immediately collecting 100 ul from a position 20 mm above the bottom of the tube. Approximately 10 ul was immediately transferred to the hemacytometer. The iron oxide particle concentration was determined with a hemacytometer by counting the number of particles in each of the four corner squares and using the total to calculate the number of particles per ml. The data shown in FIG. 20 includes the percent particles resuspended which was calculated by dividing the observed particle concentration by the Control particle concentration and multiplied by 100 . . . . The control particle concentration was calculated as an average of three replicates where the aluminum oxide/water mixture 100 ul sample was collected after 5 seconds of vigorously inverting the tube with the aluminum oxide water mixture and sampling 100 ul at a height of 20 mm above the tube bottom.

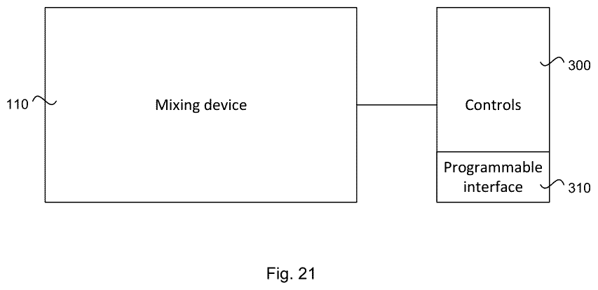

The mixing device 100 may include control circuitry 300 (FIG. 21) for controlling the operation of the motors. In one embodiment, the control circuitry may provide coordinated control signals to the motors to drive the motors in a predetermined pattern. Aspects of the motor operation that may be controlled include the frequency or speed and the synchronicity of the motors relative to each other. The motors may all be driven at one speed or at different speeds. In one embodiment, the frequency or speed of the motors may be set as a dial on the device. Similarly, a variable timer may be provided to set the duration of operation. An additional control may be provided to switch between a mixing cycle, as described above, or a tilting cycle, as described above. Other programs may be provided and selectable via this control. The device may include a programmable interface 310 that allows the control circuitry to be programmed.

In an alternative embodiment, a plurality of mixing devices is linked together with electrical wires. One control interface is provided that allows a user to program each of the plurality of mixing devices. Electrical power and control signals are transmitted from one mixing device to another in a serial manner. Each mixing device may be assigned a unique address, such as an IP address, for transmitting and receiving signals, in a manner that is well known in the art. One of the advantages of this architecture is to reduce the number of wires that are present in the laboratory environment. Rather than having each mixing device connected directly to the control system, the control system is connected only to the first mixing device in the series. This significantly reduces the number and length of wire used, which reduces the clutter and amount of maintenance and cleaning that must be performed.

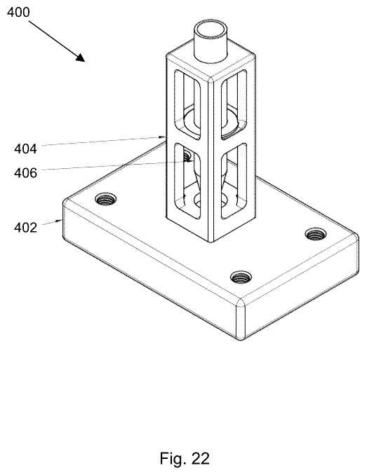

FIG. 22 shows an embodiment of a container that can be used with the mixing device. The container 400 includes a base 402 that is configured to nest snugly within the cradle of the plate nest of the mixing device. The base 402 supports a tube rack 404 that takes a single tube 406. In the embodiment depicted, the rack 404 is sized to receive a 15 ml tube. The rack may be replaced with a rack for other size tubes, e.g. a 30 ml or 50 ml tube.

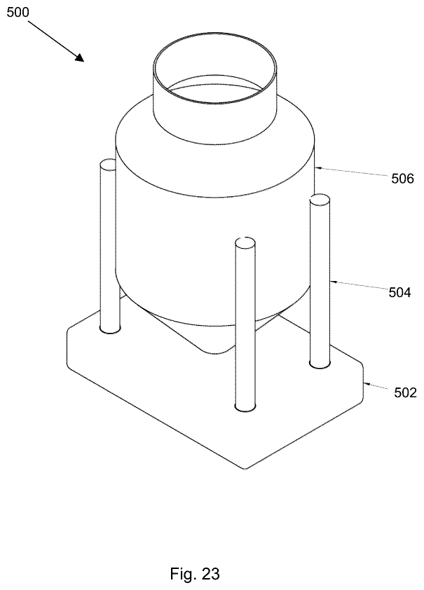

FIG. 23 shows a further embodiment of a container that can be used with the mixing device. The container 500 includes a base 502 that is configured to nest snugly within the cradle of the plate nest of the mixing device. The base 502 supports a series of posts 504 that allow a vessel 506 to retained.

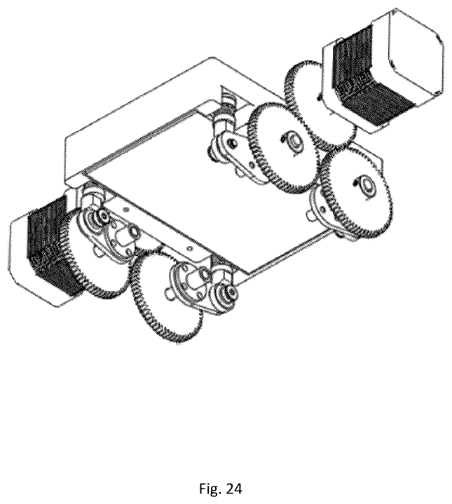

FIG. 24 depicts an alternative embodiment of the mixing device wherein the motors are coupled to the plate adapters via gears. In this embodiment, only two motors are required to drive the four mounts, with adjacent corners being driven oppositely.

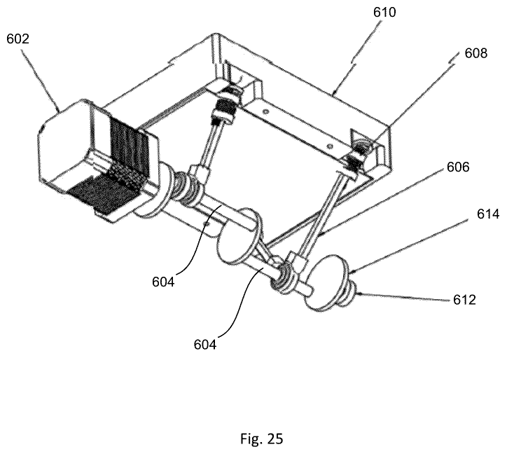

FIG. 25 shows an embodiment of a mixing device which uses a crankshaft between the motors and the mounts to produce reciprocating vertical movements of the mounts. In this embodiment, a single motor 602 outputs to a crank shaft 604 which is mounted to the frame work (not shown) at an opposite end via a mount 612. The crank shaft 604 connects via discs 614 that are offset from the center of the motor output shaft. Arms 606 connect to the crankshafts 604 and to the mounts 608. As the motor turns, the offset motion of the crankshafts 604 causes reciprocating vertical movement in the mounts 608 to move the plate nest 610.

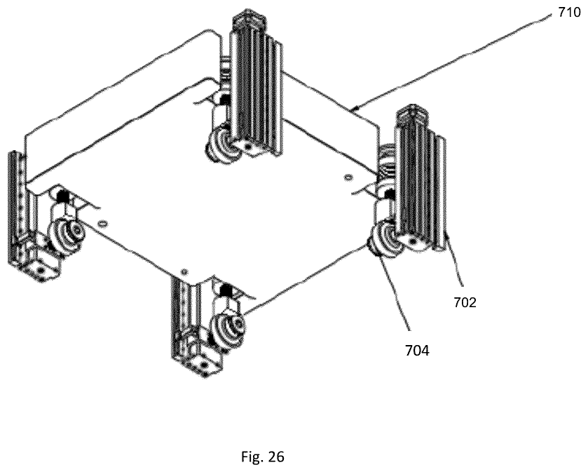

FIG. 26 shows an embodiment of the mixing device using linear drives 702 in place of the rotational output motors. The linear drives 702 drive the mounts 704 which are connected to the plate nest 710.

The invention presented herein can enable the generation of more consistent results thereby enabling redirection of the resources to increase research and development endeavors.

Many modifications and other implementations of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific implementations disclosed, and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A mixing device comprising:
(A) a framework;
(B) a plurality of motors supported by the framework;
(C) a plate nest operatively supported by the motors via a plurality of mounts; wherein the plurality of motors reciprocally drive the plurality of mounts in a vertical direction.

2. The mixing device of claim 1 wherein the plurality of motors are configured to drive the plurality of mounts to cause a vortex motion to be established in a container supported by the plate nest.

3. The mixing device of claim 1 wherein the plurality of motors drive the plurality of mounts non-synchronously.

4. The mixing device of claim 1 wherein the plurality of mounts are driven so that the mounts reach their peak height sequentially.

5. The mixing device of claim 4 wherein the plurality of mounts is driven so that the mounts reach their peak height sequentially in a circle.

6. The mixing device of claim 1 wherein the plate nest is substantially rectangular and wherein the plurality of mounts attaches to the plate nest adjacent corners of the plate nest.

7. The mixing device of claim 6 wherein there are four motors.

8. The mixing device of claim 1 wherein the plurality of mounts each includes an adapter plate that receives an output shaft of one of the plurality of motors and converts rotational motion of the output shaft into vertical motion.

9. The mixing device of claim 1 wherein the plate nest defines a cradle for receiving a container.

10. The mixing device of claim 9 wherein the container includes a adapter base that is configured to nest within the cradle.

11. The mixing device of claim 1 wherein the plurality of motors comprises one or more linear drives.

12. A method for mixing the contents of a container using a mixing device, the mixing device comprising:
(A) a framework;
(B) a plurality of motors supported by the framework;
(C) a plate nest operatively supported by the motors via a plurality of mounts;
wherein the plurality of motors reciprocally drive the plurality of mounts in a vertical direction;
the method comprising:
(D) disposing at least one container in the plate nest;
(E) operating the motors to induce a mixing motion in the container.

13. The method of claim 12 comprising coordinating the operation of the motors to produce a vortex motion in the container.

14. The method of claim 12 comprising coordinating the operation of the motors so that the mounts reach a peak height sequentially.

15. A mixing device comprising:
(A) motor means for outputting a drive motion;
(B) frame means for supporting the motor means;
(C) mount means for converting drive motion of the motor means to reciprocating vertical motion;
(D) plate nest means supported by the mount means for receiving at least one container.

16. The mixing device of claim 15 comprising control means for driving the motor means non-synchronously.

17. The mixing device of claim 16 wherein the control means drives the motor means such that the mount means reach a peak height sequentially in a circle.

18. The mixing device of claim 15 wherein the mount means support corners of the plate nest means.

19. The mixing device of claim 15 wherein the plurality of motors comprises one or more motors outputting circular motion.

20. The mixing device of claim 15 wherein the plurality of motors comprises one or more linear drives.
